(19) United States
(12) Patent Application Publication
(10) Pub. No.: US 2026/0246186 A1
(43) Pub. Date: Aug. 20, 2026

(54) POWER PLUGS FOR PANELS OF SECTIONAL DOORS

(71) Applicant: CornellCookson, LLC, Mountain Top, PA (US)

(72) Inventors: Alexander Alvarez Avila, Phoenix, AZ (US); Richard Ryan Severson Carroll, Loveland, OH (US); Andrey Vasiliyevich Melguy, Tempe, AZ (US)

(73) Assignee: CornellCookson, LLC, Mountain Top, PA (US)

(21) Appl. No.: 19/165,246

(22) PCT Filed: Mar. 21, 2023
(86) PCT No.: PCT/US2023/015833

§ 371 Date: Sep. 15, 2025

(51) Int. Cl. H01R 13/46; E05D 15/24; E06B 3/48

(52) U.S. Cl. CPC H01R 13/46; E05D 15/242; E06B 3/485

(57) ABSTRACT

In example implementations, a power plug for panels of a sectional door is provided. The power plug includes a first end comprising a first plug, a second end comprising a second plug, and a flexible housing coupled to the first end and the second end, wherein the flexible housing encloses electrical wiring connecting the first plug and the second plug.

### BACKGROUND

Doors can be used for a variety of applications. For example, doors can be used as in residential locations or doors for bays and entrances to warehouses in commercial locations. Some doors may include sectional doors. One type of sectional door may be garage doors.

Sectional doors may be made from a plurality of individual sections that are mechanically coupled together. The size and number of sections may be determined based on a size of the opening of the garage or any other type of location with an opening. One or more of the sections may have a wheel or endlock that can fit into a track. The track may guide movement of each section of the sectional door while opening and closing. The sectional door can be opened and closed manually with the help of a spring (e.g., a torsion spring or an extension spring) and in combination with a garage door opener or operator.

### BRIEF DESCRIPTION OF THE DRAWINGS

FIG. 1 illustrates a block diagram of an example sectional door with a power plug of the present disclosure;

FIG. 2 illustrates a close up view of an example of a power plug of the present disclosure;

FIG. 3 illustrates an example of a face on view of the power plug on adjacent panels of the present disclosure;

FIG. 4 illustrates a cross-sectional view of an example power plug of the present disclosure;

FIG. 5 illustrates an example of the power plug of the present disclosure in a natural state and an extended state;

FIG. 6 illustrates an example of the power plug of the present disclosure that is extended when the panels of the sectional door are moved;

FIG. 7 illustrates a block diagram of another example of a power plug of the present disclosure; and

FIG. 8 illustrates a block diagram of another example of a power plug of the present disclosure.

### DETAILED DESCRIPTION

Examples described herein provide examples of a sectional door with power plugs for panels of sectional doors. As discussed above, doors can be used for a variety of different applications. Some doors may be sectional doors, such as those used as garage doors.

Some sectional doors may include panels with an electronic component. Providing continuous power to the panels can be difficult as the sectional door may move along a track. The movement of the sectional door and the various components of the track may make it difficult to wire the sectional door for power. The wire may become tangled or stuck along the various components of the sectional door and/or track.

The present disclosure provides a power plug that allows wiring for continuous power to sectional door. The power plug of the present disclosure can provide continuous power to adjacent panels without impeding operation of the sectional door.

The power plug may also be designed to blend into the panel. For example, the power plug may have a low profile and have a similar shape and color as the location of the panel where the power plug is inserted. The power plug may also be designed to complete a portion of the panel. For example, a corner of the panel may be cut away to receive a power plug that is shaped as the portion of the corner that was cut away.

The power plug also provides easy installation and maintenance. For example, the most likely portion of wiring to fail may be the portion between the panels that has the most movement during operation of the sectional door. As the sectional door opens and closes, the wiring between adjacent panels may be stretched and collapsed as the panels separate and come back together. Over time, the sheathing on the wiring may be eroded exposing electrical wiring or the wiring may be accidentally cut or damaged. The power plug of the present disclosure allows a user to easily remove the old power plug and install a new power plug rather than having to open the panel and re-wire the entire panel.

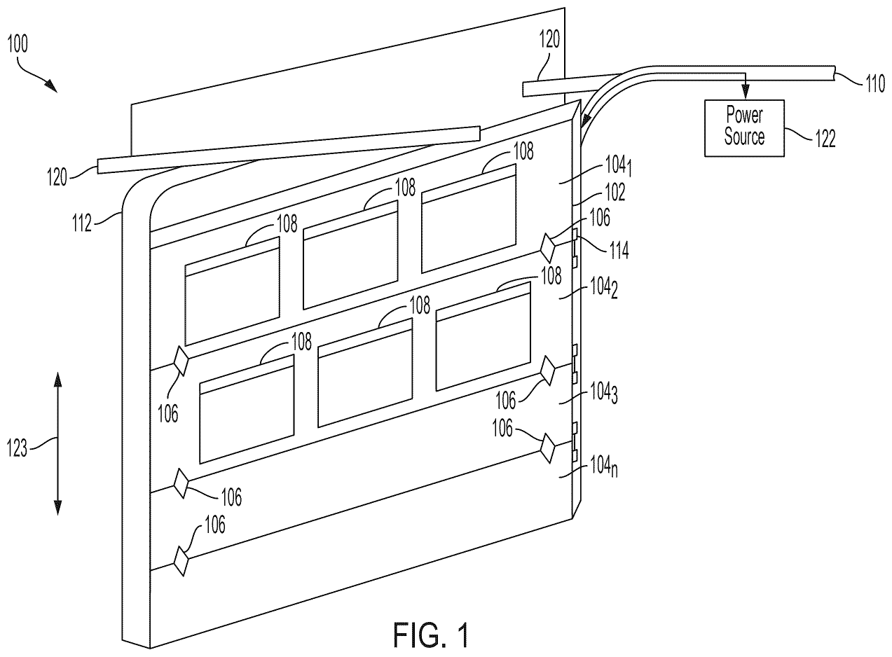

FIG. 1 illustrates a block diagram of a sectional door assembly 100 of the present disclosure. It should be noted that the sectional door assembly 100 in FIG. 1 has been simplified for ease of explanation. The sectional door assembly 100 may include additional features that are not shown. For example the sectional door 100 may include a header with a motor, rotating shaft, torsion springs, an operator, and a governor, a user interface to control operation of the sectional door, one or more sensors, and the like.

In one embodiment, the sectional door assembly 100 may include a sectional door 102 that comprises a plurality of panels or sections 104₁ to 104ₙ (hereinafter also referred to individually as a panel 104 or collectively as panels 104). The panels may be movably connected to one another via mechanical hinges 106. One or more hinges 106 may be coupled to adjacent panels 104. The first panel 104₁ may be the top most panel 104 and the last panel 104ₙ may be the bottom most panel 104.

In one embodiment, some of the panels 104 may include an electronic component 108 that requires continuous power. For example, panels 104₁ and 104₂ may have electronic components 108. In some examples, all of the panels 104 may include electronic components 108.

As noted above, delivering continuous power to an electronic component 108 within a panel 104 may be difficult. For example, traditional wiring directly to the panel may become tangled or interfere with proper operation of the sectional door 102. Traditional solutions for interior doors that have pivoting hinges that open and close a door do not accommodate the door moving from its fixed location.

The sectional door 102 may be guided by tracks 110 and 112. The tracks 110 and 112 may be installed on opposite sides of the sectional door 102. A wheel or end lock (not shown) may be inserted into the tracks 110 and 112. In the case of a garage door, the garage door may have wheels that move within the tracks 110 and 112 as the garage door opens and closes in a direction as shown by an arrow 123.

The tracks 110 and 112 may be coupled to a wall of an opening where the sectional door 102 is installed. Horizontal angle brackets 120 may be coupled to a flag bracket (not shown) that is attached to the wall may further help to stabilize the tracks 110 and 112.

In one embodiment, a continuous power supply 122 may be electrically connected to a top most panel 104₁ of the sectional door 102. In addition, adjacent panels 104₁ and 104₂ may be electrically connected via a power plug 114 of the present disclosure. In some embodiments, the panels 104₃ and 104ₙ may also include electronic components 108. In such embodiments, adjacent panels 104₂ and 104₃ may also be electrically connected via another power plug 114 and adjacent panels 104₃ and 104ₙ may also be electrically connected via another power plug 114.

In one embodiment, the power plug 114 may be connected to adjacent panels 104 along a side of the panel adjacent to the track 110 or track 112. Thus, the power plug 114 may be hidden from view.

The power plug 114 may deliver power from the power source 122 and the top most panel 104₁ to additional panels 104₂ to 104ₙ of the sectional door 102. Thus, each panel 104 may be capable of receiving continuous power to power the electronic component 108 within a respective panel 104.

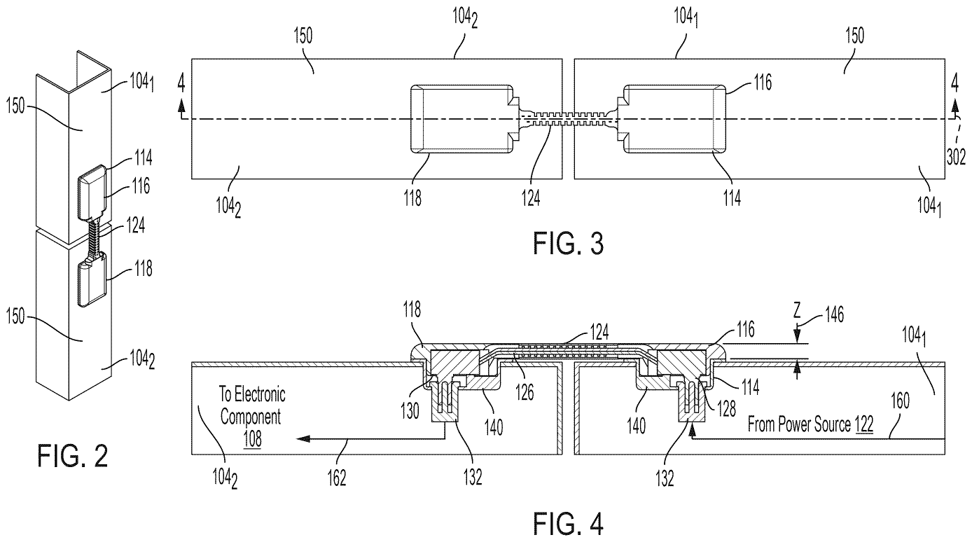

FIGS. 2 and 3 illustrate a close up view of an example of the power plug 114. FIG. 2 illustrates an isometric view and FIG. 3 illustrates a face on view.

In one embodiment, the power plug 114 may include a first end 116, a second end 118, and a flexible housing 124. The first end 116 and the second end 118 may be coupled to opposite ends of the flexible housing 124. The first end 116, the second end 118, and the flexible housing 124 may be molded from a single piece of material (e.g., a plastic, a composite, and the like) or may be fabricated from different materials and coupled together (e.g., a combination of plastic and metal, although preferably non-conductive metals). The flexible housing 124 should be able to bend through multiple vectors, such as in the x-y plane, the x-z plane, and the y-z plane, from its coupled ends.

In one embodiment, the first end 116 and the second end 118 may be located near a bottom corner and a top corner of the panel 104 along a side 150 of the panel 104 that is adjacent to the track 110 or track 112. In one embodiment, all of the middle panels 104₂ to 104ₙ₋₁ may include an opening near the bottom corner and the top corner along the side 150 to receive the first end 116 or the second end 118 of the power plug 114. The top most panel 104₁ may include a single opening near the bottom corner along the side 150 and the bottom most panel 104ₙ may include a single opening near the top corner along the side 150.

FIG. 4 illustrates a cross-sectional view of the power plug 114 along a cross-section (shown by line 302 in FIG. 3). As shown in FIG. 4, electrical wiring 126 may be run from the first end 116, through the flexible housing 124, and to the second end 118. The first end 116 may include a first plug 128 and the second end 118 may include a second plug 130. The first plug 128 and the second plug 130 may each be a two-prong alternating current (AC) or direct current (DC) connector or a three-prong AC or DC connector with ground.

The panels 104 may include a recess or recessed portion 140 to receive the first end 116 and the second end 118 of the power plug 114. The recess 140 may be located along a top corner and/or bottom corner of each panel 104. The recess 140 may be shaped to be similar to a shape of the first end 116 and the second end 118 of the power plug 114. A depth of the recess 140 may also be a function of dimensions of the first end 116 and the second end 118 of the power plug 114.

The recess 140 may allow the first end 116 and the second end 118 of the power plug 114 to be inserted into the side 150 of the panel 104 and reduce a “z” height 146. Minimizing the “z” height 146 may reduce the risk of the power plug 114 getting stuck or contacting the track 110 or interfering with proper operation of the sectional door 102.

In one embodiment, each panel 104 may be fitted with a power receptacle or power socket 132. For example, the panel 104₁ may have a power receptacle 132 located within the recess 140 and the panel 104₂ may have a power receptacle 132 located within the recess 140. The power receptacle 132 in the panels 104 may be electrically connected to the electronic components 108 within the panel 104. The first plug 128 may be inserted into the power receptacle 132 in the panel 104₁ and the second plug 130 may be inserted into the power receptacle 132 in the panel 104₂. Thus, the power plug 114 may complete an electrical connection between adjacent panels 104₁ and 104₂. For example, power from the power source 122 may be moved through wiring 160 connected to the power receptacle 132 in the panel 104₁, across the power plug 114, to the power receptacle 132 in the panel 104₂, and to the electronic component 108 via wiring 162 connected to the power receptacle 132 in the panel 104₂.

As noted above, the power plug 114 may also include the flexible housing 124. The flexible housing 124 may be a cord that can be expanded and collapsed or moved to account for gaps created between the adjacent panels 104₁ and 104₂ when the sectional door 102 is moving.

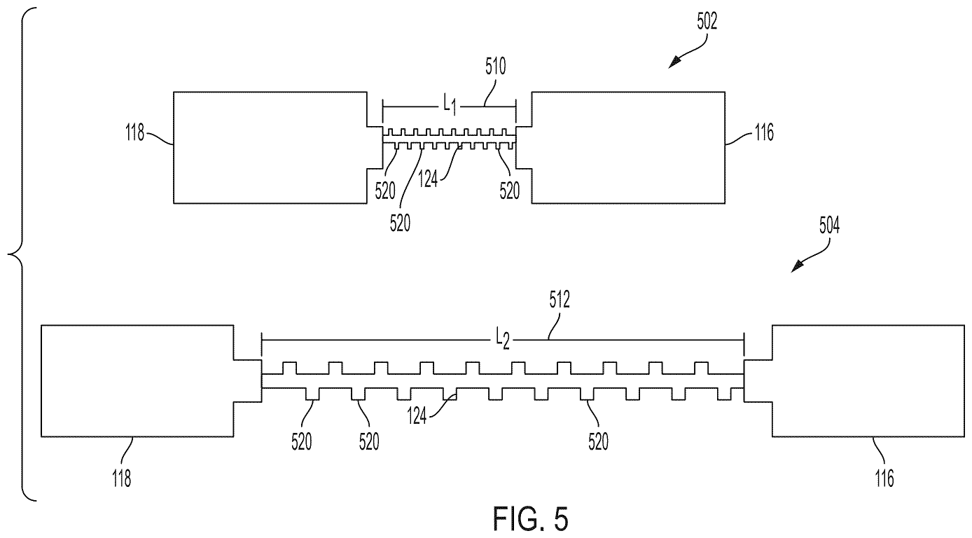

FIG. 5 illustrates an example natural state 502 and an extended state 504 of the flexible housing 124. In the natural state 502, the flexible housing 124 may have a default length l₁ shown by a dimension 510. In the extended state 504, the flexible housing 124 may have a second length l₂ as shown by dimension 512. In other words, the flexible housing 124 may allow the length to vary as the first end 116 and the second end 118 are pulled apart during operation of the sectional door 102.

In one example, the flexible housing 124 may have an accordion cord design. For example, the flexible housing 124 may be fabricated with a flexing zone. The flexing zone may result from the flexible housing comprising multiple bends, multiple openings, or multiple folds 520. The material of the flexible housing 124 may be a rigid material that is able to flex due to multiple openings (living hinge), or the flexible housing 124 may be a polymeric material suitable for providing a flexing zone through structures (accordion or zig-zag folds) or through a braided structure. In other words, the flexible housing 124 may be a braided conduit, a living hinge, or a polymeric flexible conduit. The flexible housing 124 may be elastic such that the flexible housing 124 can be stretched out and then may naturally return to the natural state 502. Suitable materials may include polyethylene, such a HDPE and LDPE, polypropylene, polyester, polyamide (including nylon), polyvinyl chloride, nylon, glass fiber braid, and similar materials.

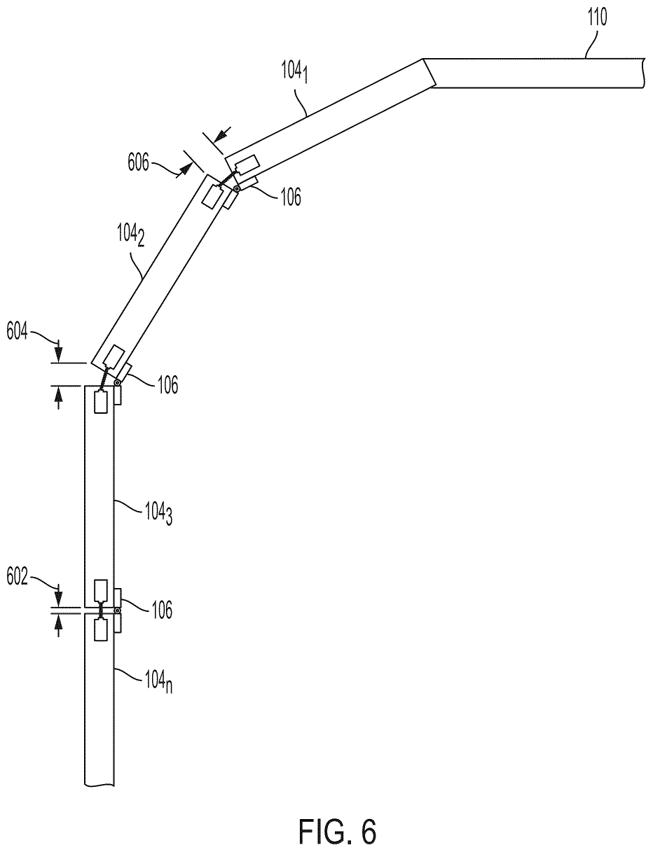

FIG. 6 illustrates an example of the power plug 114 during operation of the sectional door 102. FIG. 6 illustrates how the panels 104 may move on the track 110. When the panels 104 are in a vertical portion of the track 110, a distance 602 between adjacent panels 104 may be at a minimum. For example, the distance 602 may be zero, or in other words, there may be no gap between adjacent panels 104.

However, as the sectional door 102 is opening and moving up along the track 110, the panels 104 may enter a curved section of the track 110. Within the curved section of the track 110, the adjacent panels 104 may begin forming larger gaps separated by a distance 604 and 606. Eventually, when the panels 104 are in the horizontal section of the track 110, the gap may return to a minimum distance 602.

The distance 604 may be greater than the distance 602. The distance 606 may be greater than the distances 604 and 602. In other words, the gap may grow larger as the adjacent panels 104 separate slightly while moving through the curved section of the track 110.

As a result, a power cord with a fixed length hinge or cord would not accommodate the changes in gap size as the sectional door 102 is moving. As the distance grows from 602 to 606, the power cord could become detached or broken. However, the present disclosure provides a power plug 114 with a flexible housing 124 that can accommodate the changes in the distances 602, 604, and 606 between adjacent panels 104 as the sectional door 102 operates.

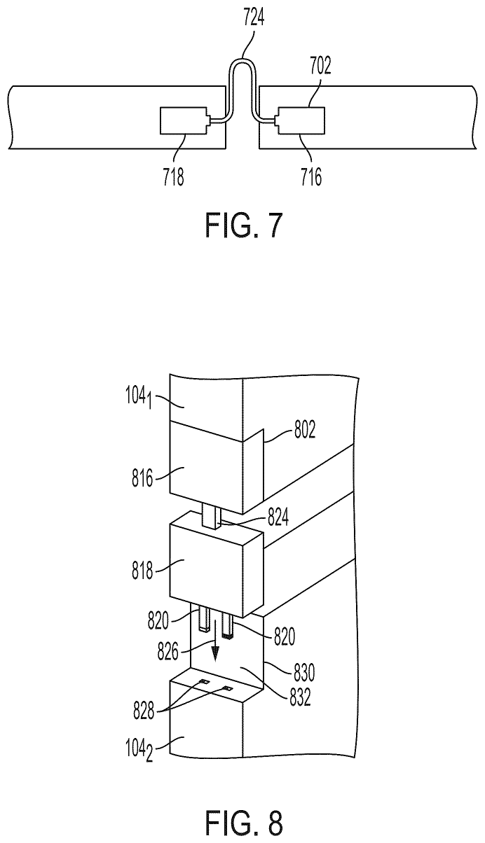

FIG. 7 illustrates a block diagram of another example of a power plug 702. In one embodiment, the power plug 702 may include a first end 716, a second end 718 and a flexible housing 724. The first end 716 and the second end 718 may also have a first plug 116 and a second plug 118 similar to the power plug 114. Wiring may also be run inside of the first end 716, the flexible housing 724, and the second end 718, similar to the power plug 114.

However, the flexible housing 724 of the power plug 702 may not have an accordion cord design. Rather, the flexible housing 724 may have a length that is greater than the maximum distance between adjacent panels 104 during operation of the sectional door 102. For example, using the example from FIG. 6, if the maximum distance 606 is 0.5 inches, the flexible housing 724 may have a length that is greater than 0.5 inches.

In one embodiment, the flexible housing 724 may have a length that is no more than 10% greater than the maximum distance between adjacent panels 104. For example, having an arbitrarily long length for the flexible housing 724 may cause the flexible housing 724 to get pinched between adjacent panels 104 as the adjacent panels 104 come back together in the vertical or horizontal section of the track 110. This may cause the flexible housing 724 to snag or get cut during operation of the sectional door 102.

In one embodiment, the flexible housing 724 may be curved in a natural state. In the extended state, the flexible housing 724 may be stretched to straighten the curve out of the flexible housing 724.

Thus, although a few example designs of the flexible housing 124 and 724 are illustrated in the present disclosure, it should be noted that there may be other ways to deploy the flexible housing 124 and 724.

FIG. 8 illustrates a block diagram of another example of a power plug 802 of the present disclosure. The power plug 802 may have a first end 816, a second end 818, and a flexible housing 824. The flexible housing 824 may be an accordion cord design similar to the flexible housing 124 or similar to the flexible housing 724 with a length greater than a maximum distance between adjacent panels 104.

However, the first end 816 and the second end 818 may have a shape that is identical to a portion of a corner 832 of the panel 104 that is removed. In other words, when the first end 816 and the second end 818 are connected to adjacent panels 104, the first end 816 and the second end 818 may appear to be part of the respective panels 104₁ and 104₂. Said another way, the first end 816 and the second end 818 may appear to be a continuous part of the panel 104₁ and 104₂, respectively.

In one embodiment, the first end 816 and the second end 818 may each include a plug 820 similar to the plugs 128 and 130 of the power plug 114. A power receptacle 828 may be inserted into the corner 832 of the panels 104. The plug 820 may be inserted into the power receptacle 828.

In some embodiments, the connection of the plug 820 to the power receptacle 828 may be sufficient to mechanically connect the power plug 802 to the panel 104. In some embodiments, the corner 832 of the panel 104 may include an additional mechanical feature 830 to provide more security in the connection. For example, the mechanical feature 830 may be an interlocking slide mechanism. For example, the first end 816 and the second end 818 may include a slide cutout along the edges on the back side (not shown). The slide cutout may mate with the interlocking slide mechanism on the corner 832 of the panel. This may ensure that the first end 816 and the second end 818 are held against the panel 104.

Although the mechanical feature 830 is described as an interlocking slide mechanism, it should be noted that other mechanical designs may be deployed. For example, the mechanical feature 830 may be interlocking tabs and slots, an interference fit, extended members on the first end 816 and the second end 818 that are inserted into corresponding openings in the corner 832 of the panel 104, and the like.

Thus, the present disclosure provides a power plug for sectional doors that allows continuous power to be delivered to adjacent panels for sectional doors. The power plug may be designed to be part of the panel such that the power plug does not interfere with the operation of the sectional door. As a result, any panel of the sectional doors may have continuous power delivered to electronic components within the panels that may require continuous power.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A power plug for a sectional door, comprising:
a first end comprising a first plug to be coupled to a first panel of the sectional door;
a second end comprising a second plug to be coupled to a second panel of the sectional door; and
a flexible housing coupled to the first end and the second end, wherein the flexible housing encloses electrical wiring connecting the first plug and the second plug.

2. The power plug of claim 1, wherein the flexible housing comprises an accordion cord, a braided conduit, a living hinge, or a polymeric flexible conduit.

3. The power plug of claim 1, wherein the flexible housing has a length that is greater than a maximum gap between adjacent panels of the sectional door while the sectional door is opening.

4. The power plug of claim 1, wherein the first plug is to mate with a first receptacle along a side of the first panel and the second plug is to mate with a second receptacle along a side of the second panel that is adjacent to the first panel.

5. The power plug of claim 1, wherein the first end comprises a same shape as a corner of the first panel and the second end comprises a same shape as a corner of the second panel.

6. The power plug of claim 5, wherein the first end is mechanically coupled to the corner of the first panel and the second end is mechanically coupled to the corner of the second panel such that the first end and the second end appear to be a continuous part of the first panel and the second panel.

7. A power plug assembly for a sectional door, comprising:
a first panel, wherein the first panel comprises a first power receptacle along a lateral side of the first panel;
a second panel that is adjacent to the first panel, wherein the second panel comprises a second power receptacle along a lateral side of the second panel; and
a power plug coupled to the first panel and the second panel, wherein the power plug comprises:
a first end comprising a first plug connected to the first power receptacle;
a second end comprising a second plug connected to the second power receptacle; and
a flexible housing coupled to the first end and the second end, wherein the flexible housing encloses electrical wiring connecting the first plug and the second plug.

8. The power plug assembly of claim 7, wherein the flexible housing comprises an accordion cord, a braided conduit, a living hinge, or a polymeric flexible conduit.

9. The power plug assembly of claim 7, wherein the flexible housing has a length that is greater than a maximum gap between adjacent panels of the sectional door while the sectional door is opening.

10. The power plug assembly of claim 7, wherein the lateral side of the first panel and the lateral side of the second panel are on a same side.

11. The power plug assembly of claim 7, wherein the first end comprises a same shape as a corner of the first panel and the second end comprises a same shape as a corner of the second panel.

12. The power plug assembly of claim 11, wherein the first end is mechanically coupled to the corner of the first panel and the second end is mechanically coupled to the corner of the second panel such that the first end and the second end appear to be a continuous part of the first panel and the second panel.

13. The power plug assembly of claim 12, wherein the first end and the second end are mechanically coupled via an interlocking slide mechanism.

14. The power plug assembly of claim 7, wherein the flexible housing changes in length when the first panel separates from the second panel when the sectional door moves along a track.

15. A sectional door assembly, comprising:
a first track and a second track;
a sectional door comprising a plurality of panels, wherein the sectional door is movably coupled into the first track and the second track, wherein the first track and the second track guide a movement of the sectional door; and
a power plug to electrically connect adjacent panels of the plurality of panels of the sectional door.

16. The sectional door assembly of claim 15, wherein each of the plurality of panels comprises a recessed portion with a receptacle to receive a plug located in an end of the power plug.

17. The sectional door assembly of claim 16, wherein the recessed portion is on a top corner and a bottom corner of each panel.

18. The sectional door assembly of claim 15, wherein at least one panel of the plurality of panels below a top most panel of the plurality of panels includes an electronic component and the power plug transfers power from the top most panel to the at least one panel to power the electronic component.

19. The sectional door assembly of claim 15, wherein the power plug comprises:
a first end comprising a first plug;
a second end comprising a second plug; and
a flexible housing coupled to the first end and the second end, wherein the flexible housing encloses electrical wiring connecting the first plug and the second plug.

20. The sectional door assembly of claim 19, wherein the flexible housing comprises an accordion cord, a braided conduit, a living hinge, or a polymeric flexible conduit.
